(19) United States
(12) Patent Application Publication
(10) Pub. No.: US 2004/0246518 A1
(43) Pub. Date: Dec. 9, 2004

(54) Systems and methods for spooling a print job

(76) Inventors: Brian E. McKinley, Boise, ID (US); David L. Smith, Eagle, ID (US); James Clough, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/454,187

(22) Filed: Jun. 4, 2003

(51) Int. Cl. G06F 15/00

(52) U.S. Cl. 358/1.15; 358/1.13; 358/1.1

(57) ABSTRACT

Disclosed are systems and methods for spooling print jobs. In one embodiment, a system and a method pertain to receiving a print request with a printing device, receiving print job data associated with the print request with the printing device, storing the print job data on the printing device, and sending the print job data to a print engine of the printing device in a predetermined order.

### BACKGROUND

In shared printing systems, multiple print jobs from multiple users may be sent to a printing device at or near the same time. Due to the limited resources of most printing devices, print jobs may be accepted and printed one at a time in the order in which a connection is made to the printer. Therefore, for example, if user1 connects to the printing device first, user1's print job is printed while user2 may need to wait until printing of user1's job is completed.

Such an arrangement can yield unfair results. Specifically, a given user's print job may be “bumped” down the printing order in situations in which (i) printing is attempted, (ii) printing fails (e.g., times-out) due to the printing device being occupied with printing another user's print job, (iii) printing is retried after a delay time period, and (iv) printing again fails due to a new print job being received in the interim between the first failure and the re-attempted printing. Such “bumping” can potentially continue indefinitely, especially in view of the fact that the delay time period is typically increased (e.g., exponentially) after each failure to print.

Unfairness of the sort described above can be avoided by spooling print jobs sent by multiple users. Such spooling involves receiving the multiple print jobs and placing them in a buffer so that the jobs may be held until the printing device is ready to print them. Again because of the limited resources of most printing devices, separate hardware is normally required to facilitate such spooling, such as a print server. In such a case, the print jobs are sent to the print server, held in a queue on the print server in the order in which they were received, and passed to the printing device for printing when the printing device is ready to print them. Although such hardware facilitates printing of multiple print jobs in the order in which they are received, thereby ensuring a measure of fairness, the hardware must be both purchased and maintained, thereby also adding to the costs of building and maintaining the system.

### SUMMARY

Disclosed are systems and methods for spooling print jobs. In one embodiment, a system and a method pertain to receiving a print request with a printing device, receiving print job data associated with the print request with the printing device, storing the print job data on the printing device, and sending the print job data to a print engine of the printing device in a predetermined order.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system that facilitates public printing.

FIG. 2 is a block diagram of an embodiment of a computing device shown in FIG. 1.

FIG. 3 is a block diagram of an embodiment of a printing device shown in FIG. 1.

FIGS. 4A and 4B provide a flow diagram that illustrates an embodiment of a method for facilitating public printing using the system of FIG. 1.

FIG. 5 is a flow diagram that illustrates an embodiment of operation of a public printing client in spooling print jobs on a printing device.

### DETAILED DESCRIPTION

Disclosed herein are example embodiments of systems and methods that facilitate public printing. Although particular embodiments are disclosed, these embodiments are provided for purposes of example only to facilitate description of the disclosed systems and methods.

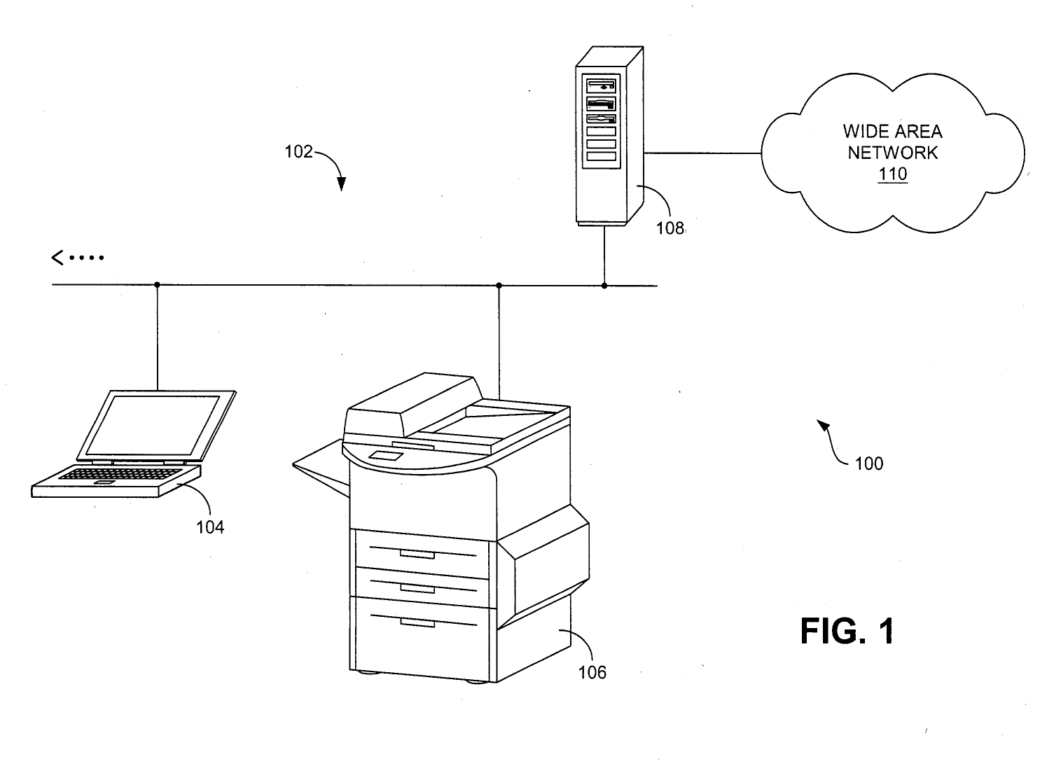

Referring now in more detail to the drawings, in which like numerals indicate corresponding parts throughout the several views, FIG. 1 illustrates an example system 100 that facilitates public printing. As indicated in this figure, the system 100 includes a local or internal network 102 to which a computing device 104, a printing device 106, and a server computer 108 are connected. The internal network 102 comprises any network (wired or wireless) that a user may wish to connect to and print over.

As is depicted in FIG. 1, the computing device 104 can be a notebook (or “laptop”) computer. More generally, however, the computing device 104 comprises any computing device with which the user may create or identify data (e.g., documents) to be printed. Irrespective of its configuration, the computing device 104 is connectable to the internal network 102 such that the computing device can communicate with one or both of the printing device 106 and the server computer 108. This connection may comprise either a wired connection or a wireless connection (e.g., via a radio frequency (RF) communication protocol). Stored on the computing device 104 is client software (or firmware) that is used to access and use a public printing service facilitated by a printing service manager.

The printing device 106 comprises any device that can receive print jobs via the internal network 102 and generate hardcopy documents associated with the received jobs. By way of example, the printing device 106 comprises a laser printer. However, other configurations are possible. For instance, the printing device 106 can be a multi-function peripheral (MFP) device that is capable of printing as well as performing other tasks such as copying, scanning, faxing, emailing, etc. As is described in greater detail below, the printing device 106 can comprise an embedded printing service manager that facilitates public printing including the spooling of print jobs.

The server computer 108 links the internal network 102 to an external wide area network (WAN) 110, such as the Internet, and therefore acts as a gateway between the internal network and the WAN. As is described below, the server computer 108 may be configured to intercept initial communications directed at devices located outside of the internal network 102 (i.e. on the WAN 110). Such interception may be used to, for example, charge users for Internet access and/or offer printing services to the user. In the latter case, the server computer 108 may be configured to provide a link to the printing service manager that, as described above, may be embedded in the printing device 106.

In addition to acting as the network gateway, the server computer 108 (or a separate computer if desired) may be used to provide the network address (e.g., Internet protocol (IP) address) of the printing service manager. Notably, in some embodiments, the printing service manager, or a portion thereof, may exist on the server computer 108 or another device connected to the network 102.

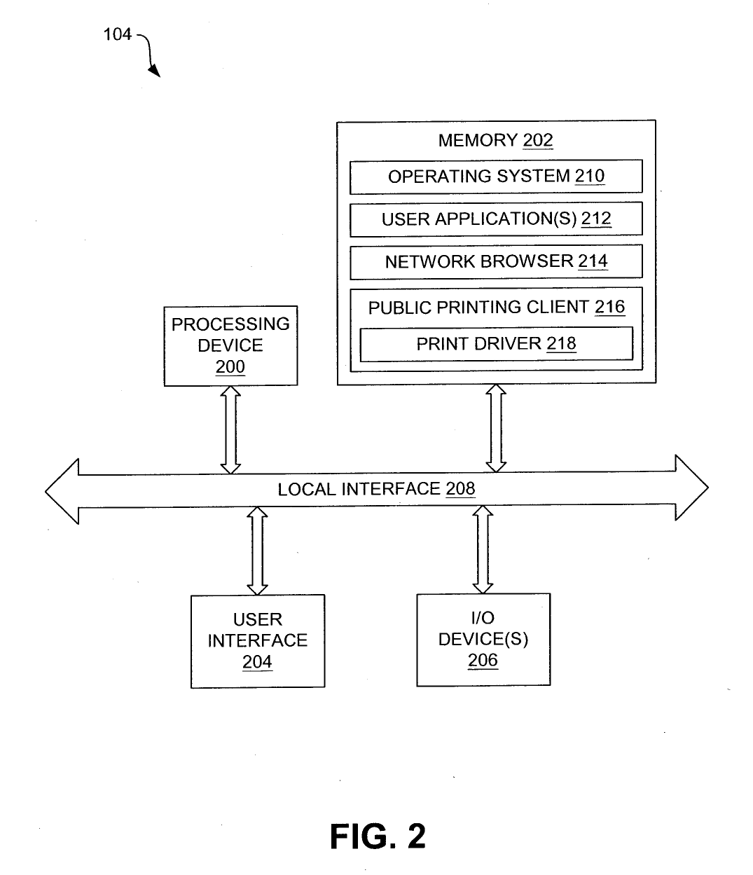

FIG. 2 is a block diagram illustrating an example architecture for the computing device 104 shown in FIG. 1. As indicated in FIG. 2, the computing device 104 comprises a processing device 200, memory 202, a user interface 204, and at least one input/output (I/O) device 206. Each of these components is connected to a local interface 208 that, for instance, comprises one or more internal buses.

The processing device 200 is adapted to execute commands stored in memory 202 and can comprise a general-purpose processor, a microprocessor, one or more application-specific integrated circuits (ASICs), a plurality of suitably configured digital logic gates, or other electrical configurations that coordinate the overall operation of the computing device 104. The memory 202 comprises any one or a combination of volatile memory elements (e.g., random access memory (RAM)) and nonvolatile memory elements (e.g., Flash memory, hard disk, etc.) that store or cache data.

The user interface 204 comprises the tools with which user data and commands are input into the computing device 104. In situations in which the computing device 104 comprises a desktop or notebook computer, the user interface 204 at least comprises a keyboard and a display. In other embodiments, the user interface may comprise one or more of function keys, buttons, a touch-sensitive display, and a stylus.

The one or more i/O devices 206 facilitate communications with other devices and may include one or more serial, parallel, small computer system interface (SCSI), universal serial bus (USB), Ethernet, or IEEE 1394 (e.g., Firewire™) components, as well as one or more of a modulator/demodulator (e.g., modem), network card, wireless (e.g., RF) transceiver, or other communication component.

The memory 202 includes various programs, in software and/or firmware, including an operating system 210, one or more user applications 212, and a network browser 214. The operating system 210 controls the execution of other software and provides scheduling, input-output control, file and data management, memory management, and communication control and related services. The user applications 212 comprise the programs that may be used to create and/or identify data (e.g., documents) that is to be printed by the service and, more particularly, by the printing device 106. By way of example, these applications comprise one or more of a word processing application, a spreadsheet application, a presentation application, a scheduling application, etc. The network browser 214 comprises a program with which the user can access, via the internal network 102, network sites and pages. By way of example, the network browser 214 is an Internet browser that retrieves Web sites and Web pages. As is described below, the network browser 214 can be used to access the printing service manager.

In addition to those programs, the memory 202 comprises a public printing client 216. As is described in greater detail below, the public printing client 216 operates in conjunction with the printing service manager to facilitate public printing. By way of example, the public printing client 216 can be downloaded from the printing service manager or from a suitable source on the WAN 110. In any case, however, once stored on the computing device 104, the public printing client 216 can be used to facilitate public printing on any network in which an appropriate printing service manager is provided, thereby providing a substantially universal printing solution.

As is further identified in FIG. 2, the public printing client 216 includes a print driver 218 that is used to translate documents into an appropriate print format. Alternatively, however, the driver 218 could comprise part of the operating system 210. In preferred embodiments, the print driver 218 is a universal driver that can be used in conjunction with substantially any printing device that may be accessed via a compatible printing service manager.

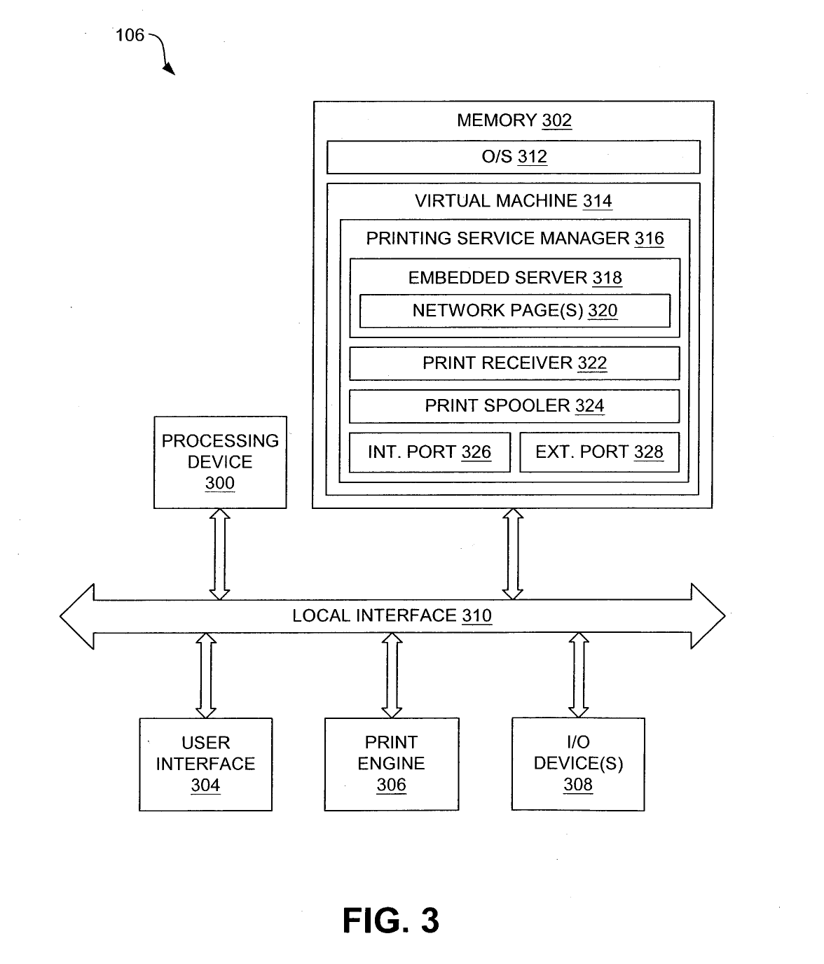

FIG. 3 is a block diagram illustrating an example architecture for the printing device 106 shown in FIG. 1. As indicated in FIG. 3, the printing device 106, like the computing device 104, comprises a processing device 300, memory 302, a user interface 304, and at least one I/O device 308, each of which is connected to a local interface 308. In addition, however, the printing device 106 comprises a print engine 306.

The processing device 300, memory 302, and I/O devices 308 have similar configurations to like-named components of the computing device 104 described in relation to FIG. 2. The user interface 304 comprises the components with which users input commands and modify device settings, such as a control panel that incorporates a display (e.g., liquid crystal display (LCD)) and a series of keys or buttons.

The memory 302 comprises various programs, in software and/or firmware, including an operating system 312 and, in this embodiment, a virtual machine 314. The operating system 312 contains the various commands that are used to control the general operation of the printing device 106. The virtual machine 314 is a program that functions as a self-contained operating environment and facilitates operation of a printing service manager 316 that, as noted above, facilitates public printing. Although a virtual machine is explicitly shown and identified, its functionality could, alternatively, be provided by software or firmware stored in the printing device 106. In the embodiment of FIG. 3, however, the manager 316 comprises an applet (e.g., written in the Chai™ programming language of the Hewlett-Packard Company) that includes an embedded server 318, a print receiver 322, and a print spooler 324.

The embedded server 318 is configured to serve network pages 320, for instance Web pages, to requesting devices such as the computing device 104. As is described below, these pages contain information for the user as to how to use the public printing system hosted by the printing service manager 316, how to obtain public printing client software, the cost of the printing services, the methods of paying for those services, etc.

The print receiver 322 is a module that is configured to receive print jobs transmitted to the printing device 106 via the internal network 102. By way of example, the print receiver 322 is specifically configured to receive hypertext transfer protocol (HTTP) and/or secure HTTP (HTTPS) communications. These communications can, for example, be received via an internal port 326 and/or an external port 328 that each has its own network address (e.g., universal resource locator (URL)) that is used to access the port. In some embodiments, the internal port 326 and the external port 328 may comprise the same port. When a print job is received, the print receiver 322 forwards the job to the print spooler 324.

As is described below, the print spooler 324 stores received print jobs in a queue of the printing device memory 302, for example in the order in which print requests are received. When the print engine 306 is prepared to print a given print job (i.e. print jobs ahead in the queue have been printed), the print spooler 324 forwards the print job to the print engine for printing.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can used by or in connection with an instruction execution system, apparatus, or device, such as a computer-based system, processor-containing system, or other system that can fetch the instructions from the instruction execution system, apparatus, or device and execute the instructions.

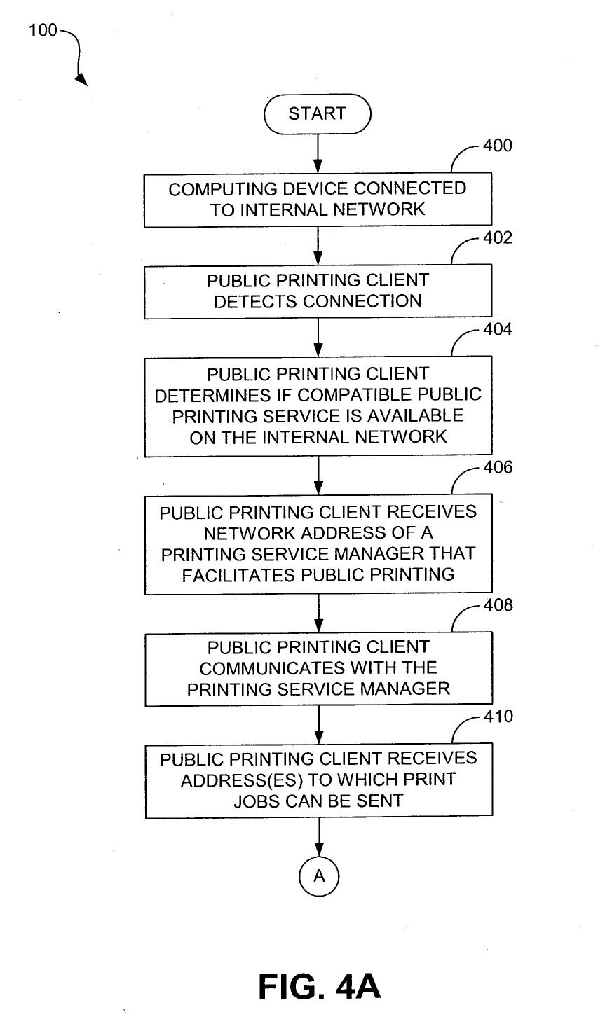

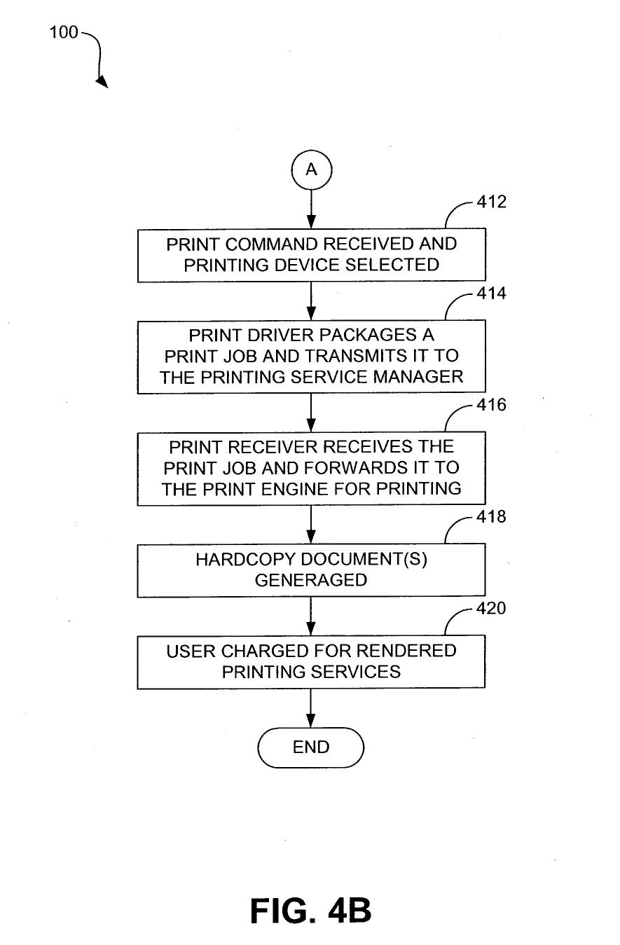

An example system having been described above, an example of operation of the system in facilitating public printing will now be discussed in relation to the flow diagram of FIGS. 4A and 4B. Process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 400 of FIG. 4A, the computing device 104 (FIG. 1) is connected to the internal network 102. Once the computing device 104 is connected to the network 102, the public printing client 216 (FIG. 2) on the computing device detects the connection, as indicated in block 402. Such detection can be made because the public printing client 216 continuously runs in the background on the computing device 104 and therefore continually monitors the network state of the device. Notably, the public printing client 216 could have been installed in a previous public printing session. For example, during that session, the computer user could have been made aware of the availability of the client software and the printing services it facilitates by, for example, a Web page served by the server computer 108. In such a case, the client software could have been obtained by, for instance, retrieving it from a server connected to the WAN 110 and operated by or on the behalf of the client software developer.

Referring next to block 404, the public printing client 216 determines if a compatible public printing service is available on the internal network 102. This determination can be made by performing a domain name service (DNS) lookup for a domain name associated with the public printing service that a DNS server (e.g., server computer 108) is configured to recognize. By way of example, a DNS lookup of the name “mobile.printing” can be performed. If a compatible public printing service is available, the public printing client 216 receives a network address of a printing service manager 316 (FIG. 3) that facilitates such public printing, as indicated in block 406. More particularly, the public printing client 216 receives an Internet protocol (IP) address of the printing service manager 316, for example stored on the printing device 106.

Once the public printing client 216 receives the address of the printing service manager 316, the public printing client makes a call to that address so that the client can communicate with the printing service manager 316, as indicated in block 408. Such communications are supported using an appropriate network protocol, such as HTTP or HTTPS. Through these communications, the public printing client 216 receives one or more network addresses to which print jobs can be sent for printing by one or more available printing devices 106, as indicated in block 410. By way of example, the address or addresses comprise one or more URLs that identify input ports (e.g., the internal and external ports) of the printing service manager 316 on the printing device 106 or the server computer 108. This information, as well as other information that facilitates printing, can, for instance, be contained in an extensible markup language (XML) document that is transmitted from the printing service manager 316 to the public printing client 216. At this point, the public printing client 216, and therefore the computing device 104, has completed a public printing service discovery process and therefore is prepared to print to the printing device 106.

The user can learn about the public printing service in various ways. For example, when the user opens the network browser 214, the server computer 108 can intercept that connection and inform the user as to the availability of the public printing service and provide a link to the printing service manager 316. Assuming the user wishes to use or is considering using the public printing service, the user can then select the link and receive one or more network (e.g., Web) pages from the embedded server 318 of the printing service manager 316 that explain how to use the service, how much the service costs (e.g., price per page), how the user is billed, where printed documents may be picked up, etc.

At print time, a print command is received and a printing device is selected, as indicated in block 412 of FIG. 4B. By way of example, the print command and printing device selection are made using a “File, Print” process in which the user is presented with a list of available printing devices from which to choose. In such a case, the presented list includes the printing device 106 connected to the internal network 102. After the print command and printing device selection have been entered, and assuming the user selected the printing device 106, the public printing client 216 packages a print job and transmits it to the printing service manager 316, as indicated in block 414. Alternatively, however, packaging of the print job can have occurred previous to entry of the print command and printing device selection. Preferably, the print job is transmitted using a secure network protocol such as HTTPS. Regardless, the print job is transmitted to an address (e.g., URL) that the public printing client 216 received in block 410 described above.

After or while the print job is transmitted, the print receiver 322 of the printing service manager 316 receives the print job and, ultimately, the job is forwarded to the print engine 306 for printing, as indicated in block 416, so that, as indicated in block 418, one or more hardcopy documents are generated. Once printing has been successfully completed (in whole or in part), the user may be charged for the printing services rendered, as indicated in block 420. Such a charge can be, for instance, added to a hotel bill or forwarded to a credit card processing service for debiting of a credit card account. Assuming no other documents are to be printed, flow for the public printing session is then terminated.

As is apparent from the foregoing, it is desirable to have a printing system that prints print jobs in a predetermined order, for instance in the order in which they were received, and that does not require the purchase and maintenance of separate hardware, such as a print server. In cases in which the print service manager 316 executes on a printing device, such a result can be achieved by spooling print jobs directly on the printing device.

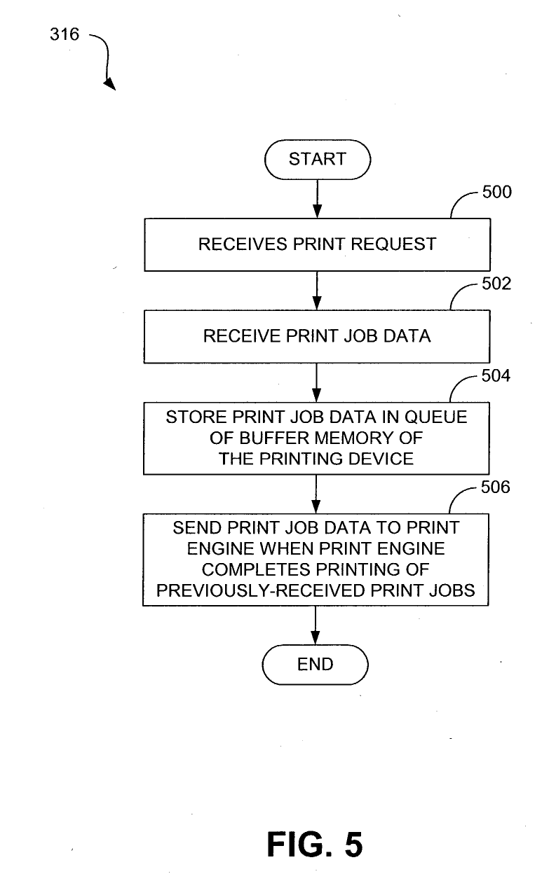

FIG. 5 is a flow diagram that describes an example embodiment of a method for spooling a print job. More particularly, FIG. 5 illustrates an example of operation of the printing service manager 316 (FIG. 3) executing on the printing device 106 (FIG. 1) in spooling a print job on the printing device.

Beginning with block 500 of FIG. 5, the printing service manager 316 executing on the printing device 106 receives a print request. By way of example, this request can have been received via a port (e.g., internal port 326 or external port 328) by the print receiver 322, and may have been contained in initial packets of a print job transmitted by a public printing client 216 (FIG. 2). Assuming the client is authorized to use the print service, the service manager 326 next receives the print job data associated with the print job request, as indicated in block 502. As the print job data is received, the data is stored by the print spooler 324 in a print queue contained within buffer memory of the printing device 106 in a predetermined order, as indicated in block 504. By way of example, the print job data is stored in the print queue according to the order in which it was received, according to the size of the document to be printed, the priority of the user, or the like. The buffer may comprise a portion of a hard disk, RAM, or non-volatile (e.g., Flash) memory of the printing device 106, depending upon the desired implementation and the configuration of the printing device.

Once the print job data has been stored in the buffer, it is sent to the print engine 306 for printing when the print engine completes printing of previously-received print jobs, as indicated in block 506. Specifically, the print spooler 324 sends the print job data stored in the queue to the print engine 306 once print job data ahead in the queue has been similarly sent to the engine and printed. At this point, flow for the spooling session is terminated and can be repeated as new print requests/jobs are received.

In the example embodiment described above, spooling is provided directly on the printing device 106. Because of this fact, fairness is ensured by printing jobs in the order in which print requests are received without the need for separate hardware such as a print server or other computer.

What is claimed is:

1. A method for spooling a print job, comprising:
receiving a print request with a printing device;
receiving print job data associated with the print request with the printing device;
storing the print job data on the printing device; and
sending the print job data to a print engine of the printing device in a predetermined order.

2. The method of claim 1, wherein sending the print job data to a print engine in a predetermined order comprises sending the print job data to the print engine in an order in which print requests were received by the printing device.

3. The method of claim 1, wherein storing the print job data comprises storing the print job data in a print queue within buffer memory of the printing device.

4. The method of claim 3, wherein storing the print job data in a print queue comprises storing the print job data on a hard disk of the printing device.

5. The method of claim 3, wherein storing the print job data in a print queue comprises storing the print job data in random access memory (RAM) of the printing device.

6. The method of claim 3, wherein storing the print job data in a print queue comprises storing the print job data in non-volatile memory of the printing device.

7. The method of claim 1, wherein sending the print job data comprise sending the print job data to the print engine after print job data stored ahead in a print queue has been sent to the print engine.

8. A system for spooling a print job, comprising:
means provided on a printing device for receiving a print request;
means provided on the printing device for receiving print job data associated with the print request;
means provided on the printing device for storing the print job data on the printing device; and
means provided on the printing device for sending the print job data to a print engine of the printing device in a predetermined order.

9. The system of claim 8, wherein the means for receiving a print request and the means for receiving the print job data comprise a print receiver that executes on the printing device.

10. The system of claim 8, wherein the means for storing the print job data and the means for sending the print job data comprise a print spooler that executes on the printing device.

11. A printing device, comprising:
a print engine;
a processing device; and
memory comprising a printing service manager that is configured to receive print requests, receive print job data associated with the print requests, store the print job data on the printing device, and send print job data to a print engine in a predetermined order.

12. The printing device of claim 11, wherein the print service manager is configured to send print job data to the print engine in an order in which the print requests were received.

13. The device of claim 12, further comprising buffer memory and wherein the printing service manager is configured to store the print job data in a print queue within the buffer memory.

14. The device of claim 13, wherein the buffer memory comprises part of a hard disk of the printing device.

15. The device of claim 13, wherein the buffer memory comprises part of random access memory (RAM) of the printing device.

16. The device of claim 13, wherein the buffer memory comprises part of non-volatile memory of the printing device.

17. A printing service manager stored on a computer-readable medium and configured to execute on a printing device, the manager comprising:
logic configured receive print requests sent to the printing device;
logic configured to receive print job data associated with the print requests sent to the printing device;
logic configured to store the print job data on the printing device; and
logic configured to send print job data to a print engine in a predetermined order.

18. The manager of claim 17, wherein the logic configured to send print job data is configured to send print job data to the print engine in an order in which the print requests were received by the logic configured to receive print requests.

19. The manager of claim 17, wherein the logic configured to store the print job data is configured to store the print job data in a print queue within buffer memory of the printing device.
